(19) United States
(12) Patent Application Publication
(10) Pub. No.: US 2002/0194951 A1
(43) Pub. Date: Dec. 26, 2002

(54) Snap clip-in bicycle pedal system

(76) Inventor: Michael R. Lowe, Boulder, CO (US)

Correspondence Address: WILLIAM E HEIN, PO BOX 335, LOVELAND, CO, 80539-0335, US

(21) Appl. No.: 10/158,460

(22) Filed: May 24, 2002

Related U.S. Application Data
(62) Division of application No. 09/630,466, filed on Aug. 2, 2000, now abandoned.

(51) Int. Cl. G05G 1/14

(52) U.S. Cl. 74/594.6

(57) ABSTRACT

A shoe-to-pedal attachment system for bicyclists includes a shoe ring formed in the tread pattern of the sole of a shoe, the shoe ring having an undercut retaining edge formed along the periphery thereof and having a domed centering button formed within the retaining edge. A pedal body includes top and bottom identically-shaped pedal rings, either of which may be retained within the undercut retaining edge of the shoe ring when the bicyclist steps onto the pedal body. In an alternative embodiment, a shoe button is attached to the shoe sole, and the pedal body includes a central retaining spring that is open toward the proximal end of the pedal axle. A retaining lip formed at the open top and bottom ends of the retaining spring engages the peripheral edge of the shoe button when the bicyclist steps onto the pedal body.

### FIELD OF THE INVENTION

This invention relates to shoe-to-pedal attachment systems used by bicyclists and, more particularly, to a clip-in shoe-to-pedal attachment system that is light weight, simple to manufacture, easy for the bicyclist to use, and that provides full ankle float and good mud clearance.

### BACKGROUND AND SUMMARY OF THE INVENTION

Various bicycle shoe-to-pedal attachment systems are known in the prior art. These prior art systems typically do not have a safety release feature and are therefore potentially dangerous in a fall. They are also typically directional during step-in and have a small step-in target area. To release them requires the rather awkward motion of rotating the heel outward. Exemplary of the prior art is U.S. Pat. No. 6,014,914 to Ueda that describes a complex system involving multiple components. This system is disadvantageous in that it does not reliably release during falls and does not provide sufficient mud clearance and ankle float.

Accordingly, the present invention is directed to a shoe-to-pedal attachment system that provides greatly improved mud clearance and safety during falls and that enables bicyclists to engage the pedal in any direction and to disengage the pedal by simply rotating the ankle outward.

In accordance with an illustrated first embodiment of the present invention, the tread pattern of a shoe sole includes a circular shoe ring in the area of the ball of the bicyclist's foot. The shoe ring has an undercut retaining edge formed along the periphery thereof and includes a domed centering button formed inside the retaining edge. A pedal body, rotationally mounted on a pedal axle, includes top and bottom identically-shaped circular pedal rings, either of which may be retained within the undercut retaining edge of the shoe ring when the bicyclist steps onto the pedal body. The domed centering button serves to guide the bicyclist's shoe into engagement with one of the pedal rings.

In accordance with an illustrated second embodiment of the present invention, a circular shoe button is attached to the sole of a shoe in the area of the ball of the bicyclist's foot. A pedal body, rotationally mounted on a pedal axle, includes a central semi-cylindrical retaining spring that is open toward the proximal end of the pedal axle. A retaining lip is formed at the open top and bottom ends of the retaining spring for engaging the peripheral edge of the circular shoe button when the bicyclist steps onto the pedal body. Front and rear pedal locator extensions of the pedal body serve as a platform onto which the bicylist may step to rotate the pedal body into a generally horizontal position prior to engaging his or her shoe with the pedal body.

In both embodiments of the present invention, the bicyclist may simply rotate his or her ankle outwardly with little force to disengage the shoe from the pedal body. In a fall involving a higher force, disengagement will occur in any direction to provide a superior safety factor.

### BRIEF DESCRIPTION OF THE DRAWINGS

FIG. 1 is a pictorial diagram illustrating a molded shoe ring and associated domed centering button formed in the sole of a bicyclist's shoe and a pedal body for engagement with the shoe ring, in accordance with a first embodiment of the present invention.

FIG. 2 is a side view illustrating the shoe of FIG. 1 engaged with a pedal ring of the pedal body.

FIG. 3 is a front view of the pedal axle and pedal body illustrated in FIG. 1.

FIG. 4 is a top view of the pedal axle and pedal body of FIG. 3.

FIG. 5 is a bottom plan view of the sole of the shoe of FIG. 1.

FIG. 6 is a cross-sectional diagram taken along the line A-A of FIG. 5.

FIG. 7 is a pictorial diagram illustrating a shoe button mounted on the sole of a bicyclist's shoe and a pedal body for engagement with the shoe button, in accordance with a second embodiment of the present invention.

FIG. 8 is a side view illustrating the shoe button of FIG. 7 engaged with a pedal ring of the pedal body.

FIG. 9 is a top plan view of the pedal body of FIGS. 7 and 8.

FIG. 10 is a front view of the pedal body of FIGS. 7-9.

FIG. 11 is a top plan view of the shoe button of FIGS. 7 and 8.

FIG. 12 is a side view of the shoe button of FIGS. 7, 8, and 11.

### DETAILED DESCRIPTION OF THE PREFERRED EMBODIMENTS

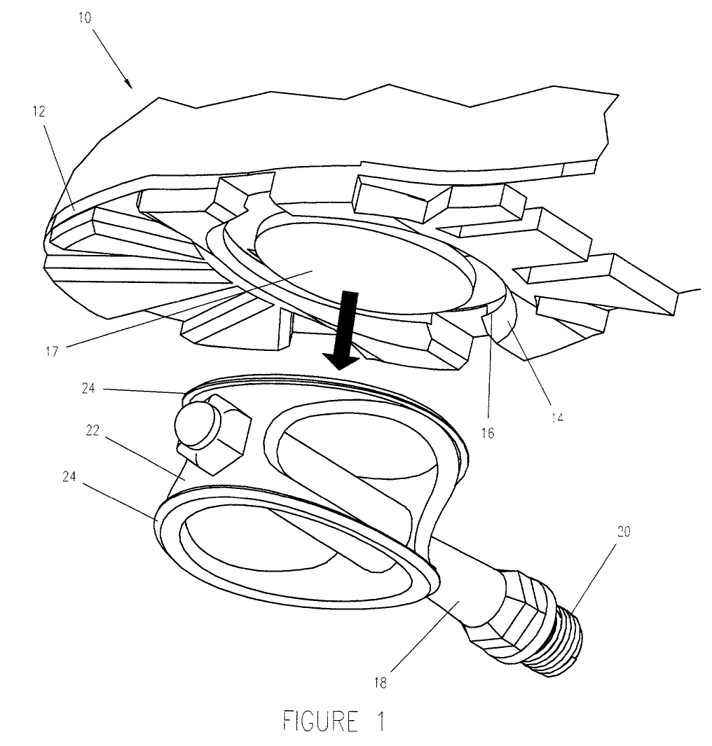

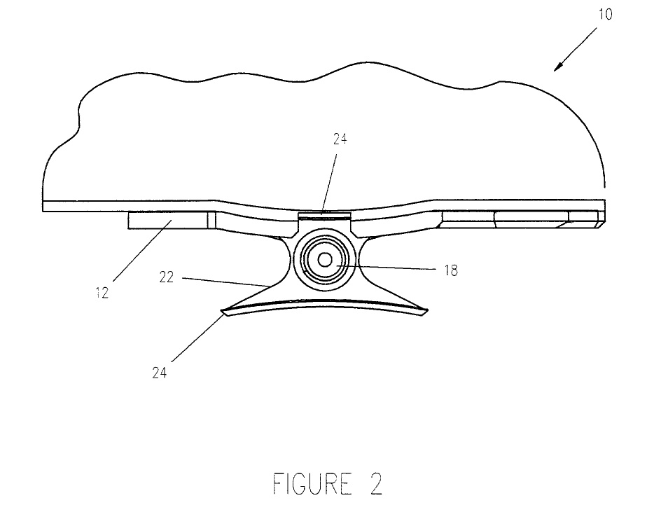

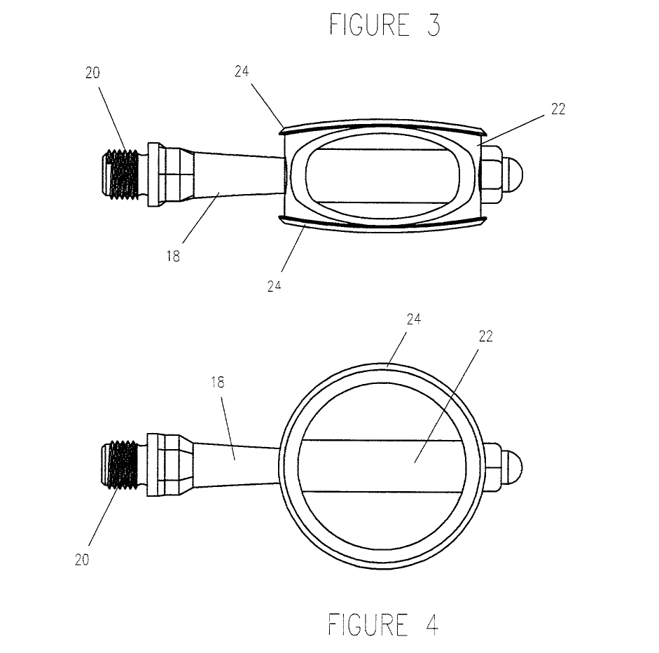

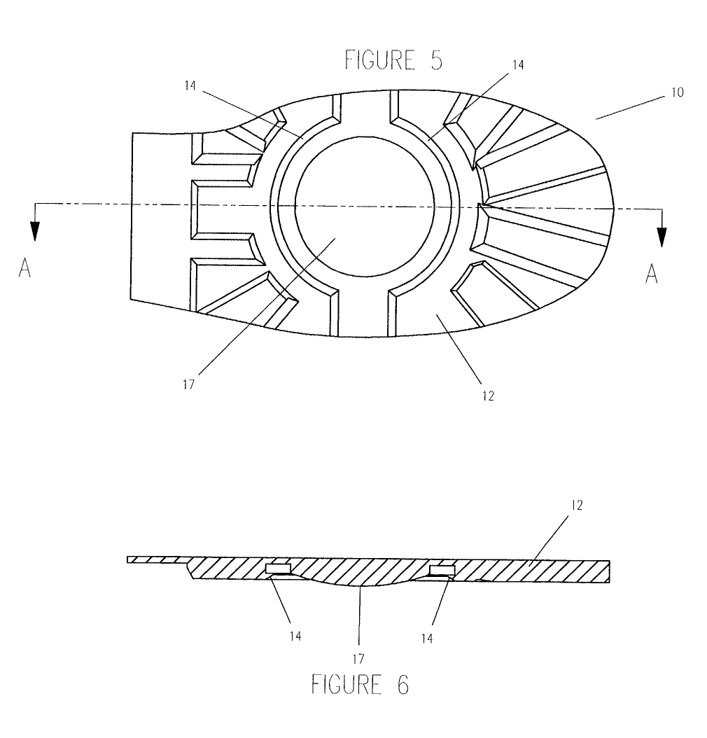

Referring now generally to FIGS. 1-6 and to FIG. 1 in particular, there is shown the front portion of a bicyclist's shoe 10 having a tread-patterned sole 12 that is conventionally formed of rubber or other suitable material. The tread pattern of sole 12 includes a circular shoe ring 14 having an undercut retaining edge 16 along the periphery thereof. A domed centering button 17 is formed within the periphery of shoe ring 14. A pedal axle 18 having crank threads 20 at a proximal end thereof is adapted for attachment to a conventional bicycle pedal crank, not illustrated. A pedal body 22 is rotationally mounted at the distal end of pedal axle 18. Pedal body 22 includes top and bottom identically-shaped circular pedal rings 24, either of which may be snapped into a position of retention within the undercut retaining edge 16 of shoe ring 14, as illustrated in FIG. 2, when the bicyclist steps onto pedal body 22. Domed centering button 17 serves to guide the bicyclist's shoe 10 into place on one of pedal rings 24. Pedal rings 24 are preferably formed to be slightly concave front to rear to conform to the correspondingly convex form of sole 12 in the area of shoe ring 14 and centering button 17. In addition, pedal rings 24 are preferably formed to be slightly convex side to side, as illustrated in FIG. 3, to conform to the correspondingly concave form of sole 12 in the same area.

As may be seen with reference to FIGS. 1, 3, and 4, pedal body 22 includes a void area within pedal rings 24 and surrounding the central portion thereof through which pedal axle 18 passes to provide mud clearance. The bicyclist may disengage shoe 10 from the position of engagement with pedal body 22 illustrated in FIG. 2 by simply rotating his or her ankle outwardly. Doing so has been found to require only about three pounds of force. In a fall, a maximum force of thirty pounds results in disengagement of shoe 10 from pedal body 22.

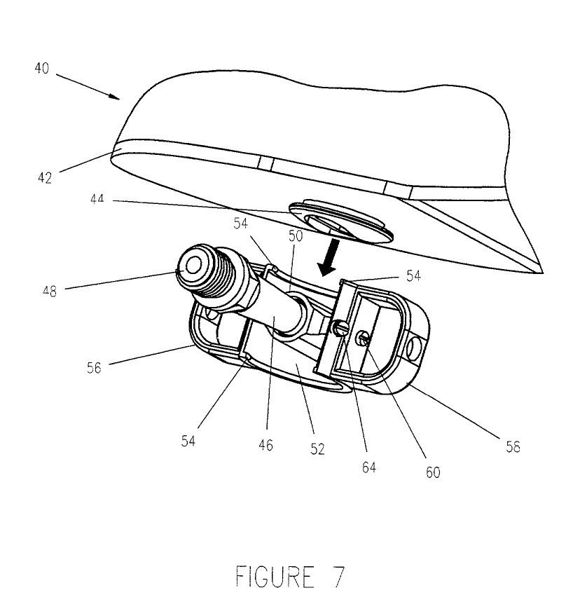

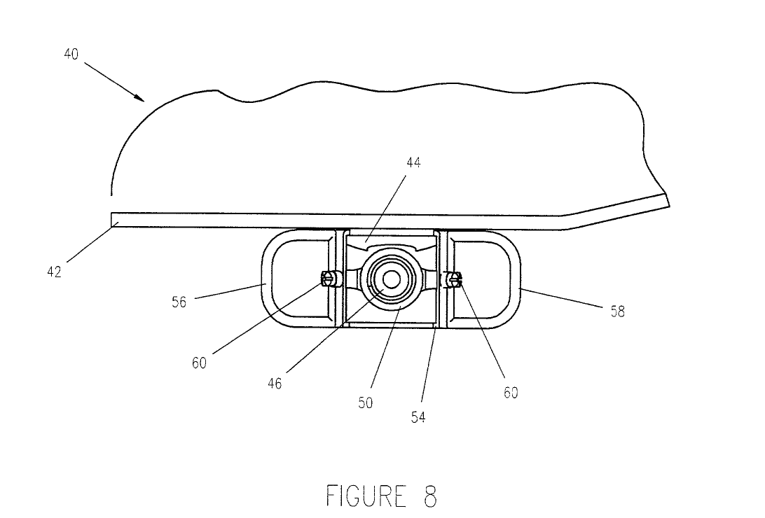

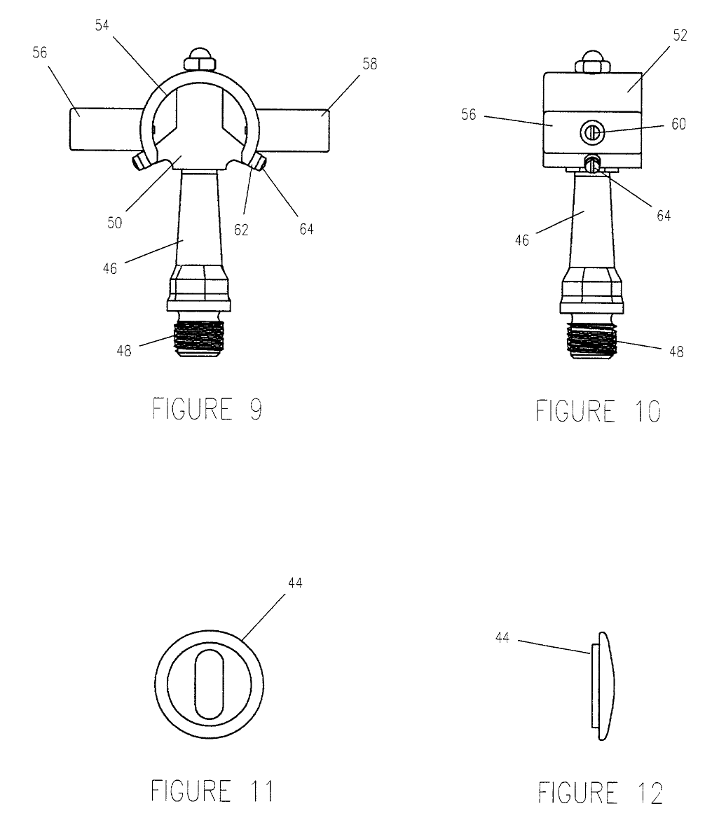

Referring now generally to the embodiment of the present invention illustrated in FIGS. 7-12 and, particularly, to FIG. 7, there is shown the front portion of a bicyclist's shoe 40 having a sole 42 that is conventionally formed of rubber or other suitable material. Sole 42, in the area of the ball of the bicyclist's foot, has a circular, domed shoe button 44 bolted or otherwise mounted thereto. Shoe button 44, which may be fabricated of metal or another suitable material, is illustrated in more detail in FIGS. 11 and 12. A pedal axle 46, having crank threads 48 at a proximal end thereof, is adapted to be attached to a conventional bicycle pedal crank. A pedal body 50 is rotationally mounted at the distal end of pedal axle 46. Pedal body 50 includes a central semi-cylindrical retaining spring 52 that is open toward a proximal end of pedal axle 46. A retaining lip 54 is formed at the open top and bottom ends of semi-cylindrical retaining spring 52 for receiving the peripheral edge of shoe button 44 when the bicyclist steps onto pedal body 50. Front and rear pedal locators 56, 58 are attached to the wall of semi-cylindrical retaining spring 52 by means of screws 60. Pedal locators 56, 58 provide a platform for the bicyclist to step on in order to rotate pedal body 50 to a generally horizontal position when it is desired to engage shoe button 44 of shoe 40 with retaining spring 52 of pedal body 50.

As illustrated in FIGS. 7 and 8, the peripheral edge of shoe button 44 snaps into retaining lip 54 at either the top or bottom of retaining spring 52 to provide engagement therebetween. The bicyclist may disengage shoe 40 from the position of engagement with pedal body 50 by simply rotating his or her ankle outwardly. Doing so has been found to require only about four pounds of force. In a fall, a maximum force of fifty pounds results in disengagement of shoe 40 from pedal body 50. The force required to disengage shoe 40 from pedal body 50 may be adjusted by means of an elastomer spring 62 and a screw 64 positioned proximate the open side of retaining spring 52 to bias retaining spring 52 with a desired force.

I claim:

1. A shoe-to-pedal attachment system for bicyclists comprising:
a shoe having a sole, the shoe having a shoe ring formed in the sole in an area of the ball of the bicyclist's foot, the shoe ring having an undercut retaining edge formed along a periphery thereof; and
a pedal body, rotationally mounted on a pedal axle, and including top and bottom identically-shaped pedal rings, adapted to be releasably retained within the undercut retaining edge of the shoe ring when the bicyclist steps onto the pedal body.

2. A shoe-to-pedal attachment system for bicyclists as in claim 1, further comprising a domed centering button formed within the periphery of the retaining edge of the shoe ring for guiding the bicyclist's shoe onto the pedal body.

3. A shoe-to-pedal attachment system for bicyclists as in claim 1, wherein the sole of the shoe is formed to be convex in a front to rear direction and concave in a side to side direction in an area of the shoe ring and the pedal rings are formed to be correspondingly concave in the front to rear direction and correspondingly convex in the side to side direction.

4. A shoe-to-pedal attachment system for bicyclists as in claim.1, wherein:
said shoe ring is circular in shape; and
said top and bottom pedal rings are correspondingly circular in shape.

5. A shoe-to-pedal attachment system for bicyclists comprising:
a shoe having a sole;
a shoe button attached to the sole in an area of the ball of the bicyclist's foot;
a pedal body, rotationally mounted on a pedal axle, and including a central retaining spring having a selected geometric shape, the retaining spring being open toward a proximal end of the pedal axle, the retaining spring having a lip formed at open top and bottom ends of the retaining spring, the retaining spring being adapted to releasably retain the shoe button within said lip when the bicyclist steps onto the pedal body.

6. A shoe-to-pedal attachment system for bicyclists as in claim 5, wherein:
said shoe button is circular in shape; and
said retaining spring is semi-cylindrical in shape.

7. A shoe-to-pedal attachment system for bicyclists as in claim 5, further comprising front and rear pedal locators attached to front and rear surfaces of the pedal body to serve as a platform onto which the bicyclist may step to rotate the pedal body into a generally horizontal position prior to engaging the shoe with the pedal body.

8. A shoe-to-pedal attachment system for bicyclists as in claim 7, further comprising an adjustment screw located proximate an open side of the retaining spring to bias the retaining spring with a desired force.

9. A shoe-to-pedal attachment system for bicyclists as in claim 8, further comprising a spring cooperating with the adjustment screw.

10. A shoe-to-pedal attachment system for bicyclists as in claim 9, wherein the spring comprises an elastomer spring.
